(19) United States
(12) Patent Application Publication
(10) Pub. No.: US 2008/0195524 A1
(43) Pub. Date: Aug. 14, 2008

(54) Techniques for effectuating an actual user consumer transaction based on an expert consumer transaction

(76) Inventor: Mark Quinlivan, Shrewsbury, MA (US)

Correspondence Address: BAINWOOD HUANG & ASSOCIATES LLC, 2 CONNECTOR ROAD, WESTBOROUGH, MA, 01581, US

(21) Appl. No.: 11/705,343

(22) Filed: Feb. 12, 2007

(51) Int. Cl. G06Q 40/00

(52) U.S. Cl. 705/37; 705/36 R

(57) ABSTRACT

An improved technique effectuates an actual user consumer transaction such as a stock trade. The technique involves providing expert performance data to a user from a database. The expert performance data is based on past expert consumer transactions which have been actually carried out by a roster of experts. The technique further involves receiving an electronic selection signal from the user. The electronic selection signal selects an expert from the roster of experts. The technique further involves automatically carrying out an actual user consumer transaction on behalf of the user in response to an electronic notification signal indicating that the selected expert has actually carried out a new expert consumer transaction. The actual user consumer transaction mirrors the new expert consumer transaction actually carried out by the selected expert.

### BACKGROUND

There are a variety of conventional approaches which enable an average stock investor to ride on the coattails of a successful stock trader. One conventional approach (hereinafter referred to as the “mutual fund approach”) involves participation of the average stock investor in a mutual fund. That is, some of the most successful stock traders manage stock mutual funds. For an average stock investor to invest in the same collection of stocks chosen by a particular manager of a mutual fund, the average stock investor can simply purchase shares of that mutual fund.

Another conventional approach which enables an average stock investor to follow a successful stock trader (hereinafter referred to as the “subscription approach”) involves the average stock investor purchasing a subscription (e.g., a newsletter, a report, etc.) from a successful stock trader. Here, the stock trader holds himself or herself out as an investment advisor who is capable of going on record in the subscription with reliable predictions of whether the prices of certain stocks will go up or down in the future. As a subscriber, the average stock investor receives stock recommendations from the investment advisor and then manually creates a stock portfolio which follows these stock recommendations.

Yet another conventional approach (hereinafter referred to as the “simulation approach”) involves the average stock investor observing the performance of mock (or simulated) stock portfolios which are shared with the public by their creators. Along these lines, some conventional web sites allow people to create mock stock portfolios and share the details of the mock stock portfolios with the general public thus enabling the general public to compare the mock stock portfolios to each other in a contest-like manner. If an average stock investor is impressed with the performance of the creator of a particular mock stock portfolio, that average stock investor can manually copy future changes to the mock stock portfolio as the creator makes changes to the portfolio over time. This manual tracking has many limitations including (i) time latency in distributing information, (ii) a requirement that any quantitative comprehensive analysis be performed manually by the public, and (iii) the inability for the creators to obtain financial compensation from the public in return for sharing the details of their mock stock portfolios. The Internet domains “caps.fool.com” and “www.marketocracy.com” are web sites which currently operate in a manner similar to that described above.

### SUMMARY

Unfortunately, there are deficiencies to the above-described conventional approaches which enable the average stock investor to follow successful stock traders. For example, the above-described conventional mutual fund approach limits the average stock investor to only a small number of successful stock traders, i.e., the number of available mutual fund managers depends on the number of available mutual funds. In addition, a mutual fund may be “closed” to new investors and thus not allow the average investor to participate. Moreover, there are successful stock traders who do not manage mutual funds and it would be advantageous to have a technique which enables the average stock investor to follow successful stock traders who are not mutual fund managers.

Additionally, in connection with the above-described conventional subscription approach, there is no guarantee that the investment advisors are truly recommending stocks that they believe are good investments. Rather, the possibility exists that a particular advisor has an ulterior motive to recommend a stock (e.g., the advisor may currently own that stock and wish to sell that stock at a high price, the advisor may have been hired to recommend that stock, etc.). Furthermore, there are also situations in which particular advisors perform worse that the market (e.g., worse than the S&P 500 Index) and worse than other individual investors. Moreover, even if a stock recommendation is good, by the time the average stock investor receives the stock recommendation from an investment advisor, a significant amount of time may have elapsed and the price of the recommended stock may have already moved substantially.

In connection with the above-described conventional simulation approach, drawbacks similar to those of the above-described conventional subscription approach exist. For instance, the creator of a mock stock portfolio may not truly endorse investment in a particular stock but nevertheless add that stock to the mock stock portfolio due to an ulterior motive. Also, even if a stock recommendation is good, a similar lag in time may exist between the time the creator adds a new stock to the mock stock portfolio and the time the average stock investor detects that addition. In the meantime, the price of the added stock may have moved significantly. Furthermore, in the simulation approach, there is no formal mechanism to financially compensate the mock stock portfolio creator for a good stock recommendation and thus no financial incentive for successful stock traders to even create mock stock portfolios to share with the public.

In contrast to the above-described conventional approaches to enabling average stock investors to follow successful stock traders, improved techniques are capable of effectuating actual consumer transactions (e.g., stock trades) in an automated manner. Such techniques involve a user choosing one or more an expert from a roster of experts based on a user-performed review of historical expert performance data. After the user has selected an expert to follow, the user configures electronic equipment to carry out a new user consumer transaction on behalf of the user in response to a new expert consumer transaction performed by the chosen expert, where the new consumer transaction mirrors (or mimics) the transaction of the chosen expert. Such operation is capable of occurring quickly and reliably for effective transaction closure. Moreover, the electronic equipment is capable of tracking such operation to enable a fair expert fee to be provided to the chosen expert as well as a fair transaction fee to be provided to the provider/maintainer of the electronic equipment.

An embodiment is directed to a method for effectuating an actual user consumer transaction. The method involves providing expert performance data to a user from a database. The expert performance data is based on past expert consumer transactions which have been actually carried out by a roster of experts. The method further involves receiving an electronic selection signal from the user. The electronic selection signal selects an expert from the roster of experts. The method further involves automatically carrying out an actual user consumer transaction on behalf of the user in response to an electronic notification signal indicating that the selected expert has actually carried out a new expert consumer transaction. The actual user consumer transaction mirrors the new expert consumer transaction actually carried out by the selected expert. One will appreciate that such a method has application in the field of securities trading (e.g., stocks, bonds, derivatives, options, notes, debts, etc.) as well as other applications such as gambling (e.g., poker, blackjack, horse racing, etc.), contests in general (e.g., video games contested between multiple parties), and the like.

In some arrangements, a user chooses one or more experts, or a complete set or subset of the selections of one or more expert selections, from a roster of experts based on a user-performed review of the historical expert performance data. After the user has selected one or more experts to follow, the user configures the electronic equipment, based on a defined set of criteria to carry out a new user consumer transaction on behalf of the user.

Additionally, in some arrangements, the actual user consumer transaction mirrors the new expert consumer transaction or a subset of the expert transactions actually carried out by the selected expert, or at a minimum allows the user to “opt in” on a transaction by transaction basis. Such arrangements enhance the flexibility and decision-leveraging capabilities of the user.

Furthermore, in some arrangements, the historical expert performance data may include data based on performance of simulated trading rather than actual performance data. Such arrangements are well suited for certain situations such as at system start-up time when actual performance data is not very available but simulated trading data is abundantly available. In yet other arrangements, the historical expert performance data may include a combination of data based on performance of simulated trading as well as actual performance data.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a block diagram of a consumer transaction system which is capable of effectuating actual consumer transactions in an automated manner.

FIG. 2 is a block diagram of support equipment of the system of FIG. 1.

FIG. 3 is a general diagram of some example data for a particular expert registered in the system of FIG. 1.

FIG. 4A is a general diagram of an example roster of experts in the system of FIG. 1.

FIG. 4B is another general diagram of the example roster of experts in the system of FIG. 1.

FIG. 5 is a block diagram of a display screen of a display of a user device which communicates with the system of FIG. 1.

FIG. 6 is an example of a dialog box 210 which is suitable as at least part of a selecting portion of the display screen of FIG. 5.

FIG. 7 is an example diagram illustrating how each participant in the system of FIG. 1 is capable of benefiting from the overall operation of the system.

FIG. 8 is a flowchart which summarizes the operation of the support equipment of FIG. 2.

FIG. 9 is a block diagram illustrating operation of the system of FIG. 1 when carrying out actual user transactions based on simulated trade data.

### DETAILED DESCRIPTION

### General

Improved techniques are capable of effectuating actual consumer transactions (e.g., stock trades) in an automated manner. Such techniques involve a user choosing an expert to follow from a roster of experts based on a user-performed review of historical expert performance data. After the user has selected an expert to follow, the user configures electronic equipment to carry out a new user consumer transaction on behalf of the user in response to a new expert consumer transaction performed by the chosen expert. As a result, the electronic equipment carries out the new consumer transaction to mirror (or mimic) the transaction of the chosen expert in a quick, effective and dependable manner. The user is capable of configuring the electronic equipment to operate in a fully automated manner in which the electronic equipment follows each expert trade with a user trade, or alternatively in an “opt in” manner in which the electronic equipment follows only a subset of expert trades based on a set of defined review criteria. Moreover, the electronic equipment is capable of tracking such operation to enable a fair fee to be provided to the chosen expert as well as a fair transaction fee to be provided to the provider/maintainer of the electronic equipment.

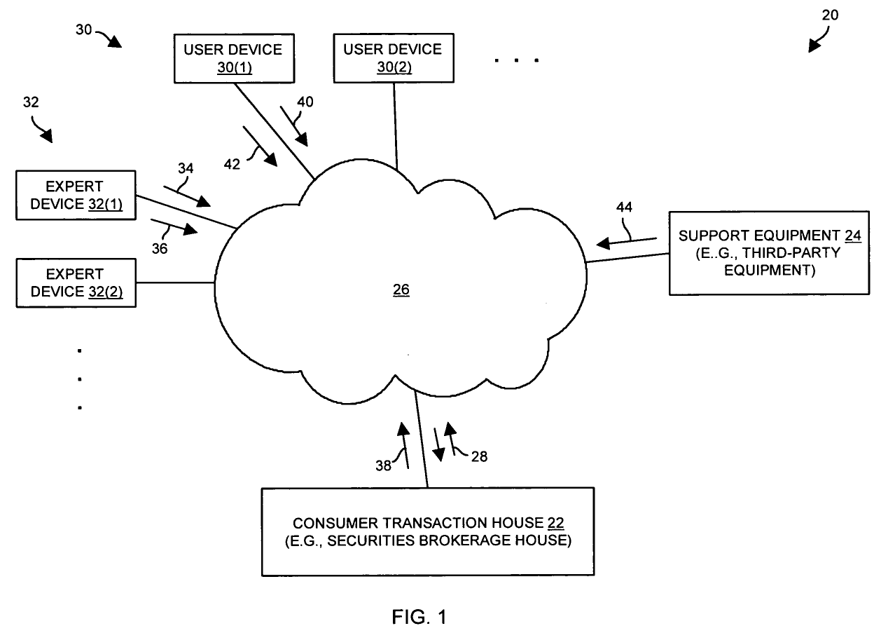

FIG. 1 shows a system 20 which is capable of effectuating actual consumer transactions (e.g., stock trades) in an automated manner. The system 20 includes a consumer transaction house 22 and support equipment 24. A network 26 (e.g., copper wire, fiber optic cable, wireless medium, related data communications devices, combinations thereof, etc.) allows the consumer transaction house 22 and the support equipment 24 to exchange signals 28 and thus communicate with each other in a robust and reliable manner.

In FIG. 1, the arrows 28 are intended to generally illustrate signals exchanged between devices on the network 26. It should be understood that there are no limitations on the physical distance between the consumer transaction house 22 and the support equipment 24 (e.g., they could reside in the same room, in separate buildings, in different cities, etc.). In some arrangements, the network 26 includes a portion of the Internet and/or a portion of a private network.

As further shown in FIG. 1, multiple user devices 30(1), 30(2), . . . (collectively, user devices 30) connect to the network 26. Each user device 30 is a communications apparatus (e.g., a personal computer running a web browser or graphical user interface; a workstation; a laptop device, an input/output kiosk, a cell phone; a pocket-sized, portable/mobile, or hand-held computerized peripheral or accessory; etc.) which enables a user to input data into and output data from the system 20.

Similarly, multiple expert devices 32(1), 32(2), . . . (collectively, expert devices 32) connect to the network 26. Each expert device 32 is also a communications apparatus (e.g., a personal computer running a web browser or graphical user interface; a workstation; a laptop device, an input/output kiosk, a cell phone; a pocket-sized, portable/mobile, or hand-held computerized peripheral or accessory; etc.) which enables an expert to input data into and output data from the system 20.

During operation, the consumer transaction house 22 and the support equipment 24 work together to enable users to carryout actual user consumer transactions which follow actual expert consumer transactions performed by experts. In particular, the experts initially provide electronic permission signals 34 to the system 20 (e.g., registering at a web site) from the expert devices 32 (e.g., see the expert device 32(1)) to allow their consumer transactions to be monitored by the support equipment 24. Either the consumer transaction house 22 or the support equipment 24 can receive these electronic permission signals 34 and coordinate with the other (e.g., see signals 28 in FIG. 1) for proper configuration by the system 20.

Then, the experts send consumer transaction signals 36 from the expert devices 32 to the consumer transaction house 22 to make actual (i.e., real) consumer transactions. In contrast to conventional web sites that enable people to view mock or hypothetical stock portfolios, the transactions handled by the system 20 are genuine. As the consumer transaction house 22 executes these actual consumer transactions on behalf of the experts, the consumer transaction house 22 sends electronic notification signals 38 to the support equipment 24 to provide notification of the expert consumer transactions. Upon receipt of the electronic notification signals 38 from the consumer transaction house 22, the support equipment 24 records the expert consumer transactions in a database. Over time, the support equipment 24 becomes a historical repository of expert consumer transaction data for a roster of experts (i.e., for all of the experts that have registered themselves in the system 20). Such operation guarantees that the expert consumer transaction data is true and not fabricated, and not based on fictitious activity.

Additionally, users provide electronic sign up signals 40 to sign up for access to services provided by the support equipment 24. The support equipment 24 responds to the electronic sign up signals 40 by providing the signed-up users with the capability of selecting experts to follow.

Next, the users operate the user devices 30 to configure the system 20 to carryout user consumer transactions which copy future expert consumer transactions of particular experts. Along these lines, the users review expert performance data from the support equipment 24 using their user devices 30. This expert performance data includes the earlier-mentioned database history of expert consumer transactions as well as performance factors derived from the expert performance data (e.g., in the context of stock trades, such performance factors are capable of including overall gains/losses, trading velocities, trading accuracies, etc.). Preferably, the users navigate through a GUI or a sophisticated set of web pages which provides filtering and/or sorting capabilities on the expert performance data thus enabling the users to narrow the roster of experts to select subsets of experts based on particular selection criteria (e.g., experts with certain average stock buy-and-hold times, certain average gain or success rates, etc.) before the users finally select specific experts to follow. Once the users have selected experts to follow (e.g., experts having past transaction profiles with suitable combinations of performance characteristics or which best match the particular investment desires of the users), the users operate the user devices 30 (e.g., see the user device 30(1)) to send electronic selection signals 42 which identify the selected experts to the support equipment 24.

In response to the electronic selection signals 42 from the users, the support equipment 24 carries out actual consumer transactions on behalf of the user which mimic future actual consumer transactions performed by the selected expert. In the context of stock trades, the user is capable of providing additional electronic signals (e.g., predefined criteria) to further customize the support equipment 24 in various ways (further illustrated by the arrow 40). For example, if the user does not wish to invest as much as the expert, the user may direct the support equipment 24 to prorate amounts, or to discount the actual expert transaction by a predefined percentage (e.g., 20%, 50%, 75%, etc.). Alternatively, the user may wish to place an absolute dollar amount limit on stock trades. Furthermore, if the user is unwilling to accept the risks associated with certain types of trades (e.g., short trading, option trading, margin trading, etc.), the user is capable of disabling such trades (again illustrated by the arrow 40). Other “opt in” or “opt out” customizations and defined review criteria are available to the user as well.

As a result of such user configuration, the support equipment 24 is now robustly configured to automatically carry out an actual user consumer transaction on behalf of a user in response to a new electronic notification signal 38 indicating that a selected expert has actually carried out a new expert consumer transaction. In particular, when the consumer transaction house 22 sends a new electronic notification signal 38 to the support equipment 24 indicating that the selected expert has performed a new consumer transaction, the support equipment 24 outputs a user transaction signal 44 directing the consumer transaction house 22 to execute an actual user consumer transaction mirroring the new expert consumer transaction. Upon receipt of the user transaction signal 44, the consumer transaction house 22 carries out a mirroring actual consumer transaction on behalf of the user.

It should be understood that the executed transaction carried out on behalf of the user is capable of causing the consumer transaction house 22 to output yet another electronic notification signal 38 to the support equipment 24 in order to report that the actual user consumer transaction has been carried out. For accounting purposes, the support equipment 24 is capable of tracking this operation and thus applying fees for the user consumer transaction. For example, in the context of stock trades, the support equipment 24 is capable of attaching a commission fee on behalf of the consumer transaction house 22 (e.g., a securities brokerage house), an expert fee which is to be provided to the selected expert, and a third-party fee which forms compensation for the work provided by the support equipment 24.

It should be further understood that users can register themselves as experts and thus be followed by other users (i.e., a user can become an expert and vice versa). Furthermore, it should be understood that the system 20 provides electronic report signals back to both the experts and the users to report the status of their consumer transactions (illustrated generally by the arrows 28). Further details of various components of the system 20 will now be provided.

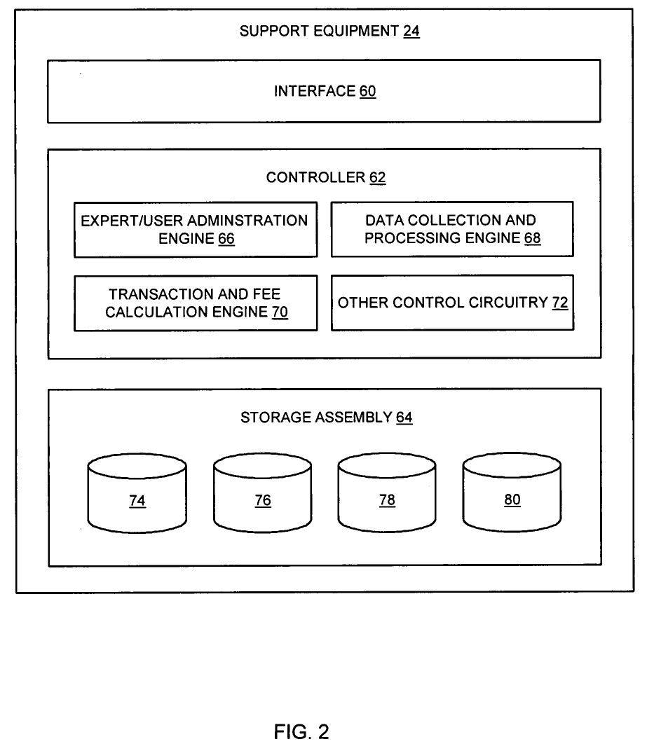

FIG. 2 shows a block diagram of the support equipment 24. As shown in FIG. 2, the support equipment 24 includes an interface 60, a controller 62, and a storage assembly 64. The interface 60 is configured to connect the support equipment 24 to the network 26 (FIG. 1). The controller 62 (e.g., a set of processors, a set of standalone computers, compute logic, etc.) is configured to exchange signals with the various devices through the interface 60 to carryout the transactional operations of the support equipment 24. The storage assembly 64 is configured to store a variety of information which is used during operation of the controller 62.

The controller 62 includes an expert/user administration engine 66, a data collection and processing engine 68, a transaction and fee calculation engine 70, and other control circuitry 72. Additionally, the storage assembly 64 includes an expert/user database 74, a transaction database 76, an operations database 78, and additional memory 80.

The expert/user administration engine 66 is configured to manage a listing of the experts and users which are handled by the system 20. In particular, as experts register with the system 20, the expert/user administration engine 66 communicates with the expert devices 32 through the interface 60 to interact with the experts (e.g., manages usernames and passwords for the experts, obtains address information for the experts, etc.), and acquire and store the data needed to operate on behalf of the experts in the expert/user database 74 (also see the electronic permission signals 34 in FIG. 1). Similarly, as users sign up on the system 20, the expert/user administration engine 66 communicates with the user devices 30 through the interface 60 to interact with the users (e.g., manages usernames and passwords for the users, obtains address information for the users, identifies the experts to be followed by the users, etc.), and acquire and store the data needed to operate on behalf of the users in the expert/user database 74 (also see the electronic sign up signals 40 in FIG. 1).

The data collection and processing engine 68 is configured to process consumer transactions reported by the consumer transaction house 22 (FIG. 1). In particular, the consumer transaction house 22 outputs an electronic notification signal 38 in response to each actual consumer transaction executed on behalf of an expert or a user. The data collection and processing engine 68 stores the consumer transaction data describing the actual consumer transactions in the transaction database 76. The data collection and processing engine 68 also generates performance data, e.g., sets of expert performance factors corresponding to the experts based on the consumer transaction data. Such generation is capable of being performed dynamically in response to new consumer transaction data, in response to requests for such performance data from a possible user, or periodically (e.g., nightly during periods of low utilization).

The transaction and fee calculation engine 70 is configured to monitor the electronic notification signals 38 in a real time manner as they are received by the support equipment 24 from the consumer transaction house 22. If any electronic notification signals 38 indicate execution of actual consumer transaction on behalf of an expert with a user following the consumer transactions of that expert, the transaction and fee calculation engine 70 initiates an actual user consumer transaction on behalf of that user, i.e., the engine 70 checks each actual consumer transaction for the prospect of initiating another actual consumer transaction if there is a following user. To this end, the transaction and fee calculation engine 70 sends instructions to the consumer transaction house 22 to execute an actual user consumer transaction on behalf of the user. The actual user consumer transaction is mirrors the actual expert consumer transaction quickly and reliably.

Additionally, the transaction and fee calculation engine 70 awaits receipt of an electronic notification signal 38 from the consumer transaction house 22 confirming execution of the actual user consumer transaction. Upon receipt of such confirmation, the transaction and fee calculation engine 70 charges the user a fair fee (e.g., a broker fee, an expert fee to be given to the expert, and a third-party fee to be given to the maintainer of the system 20) and stores this information in the operational database 78. It should be understood that the data collection and processing engine 68 processes this electronic notification signal 38 in the manner described earlier in order to store the consumer transaction in the transaction database 76.

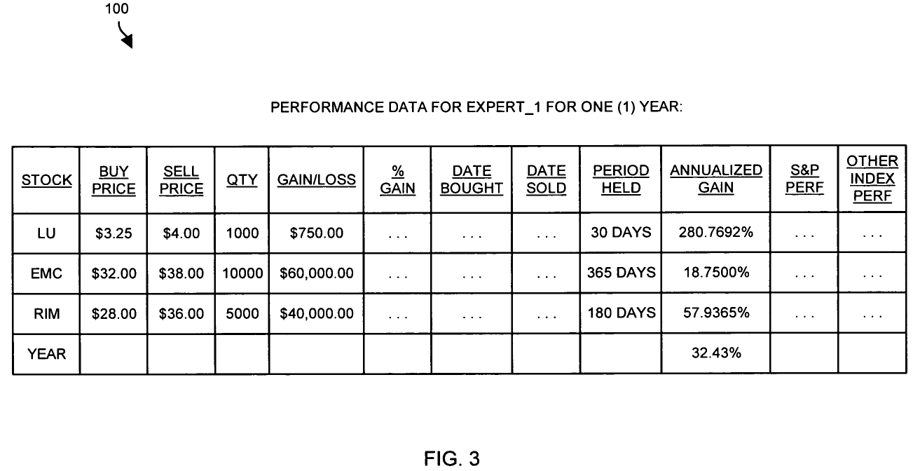

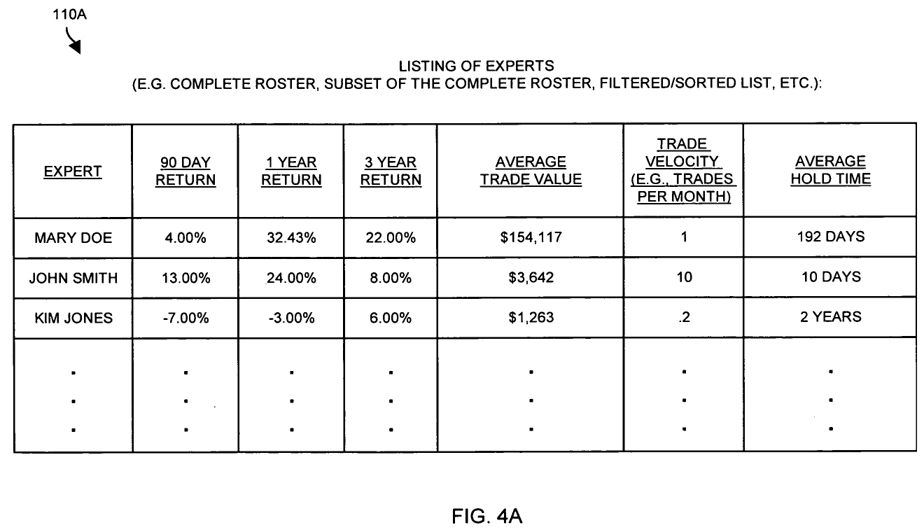

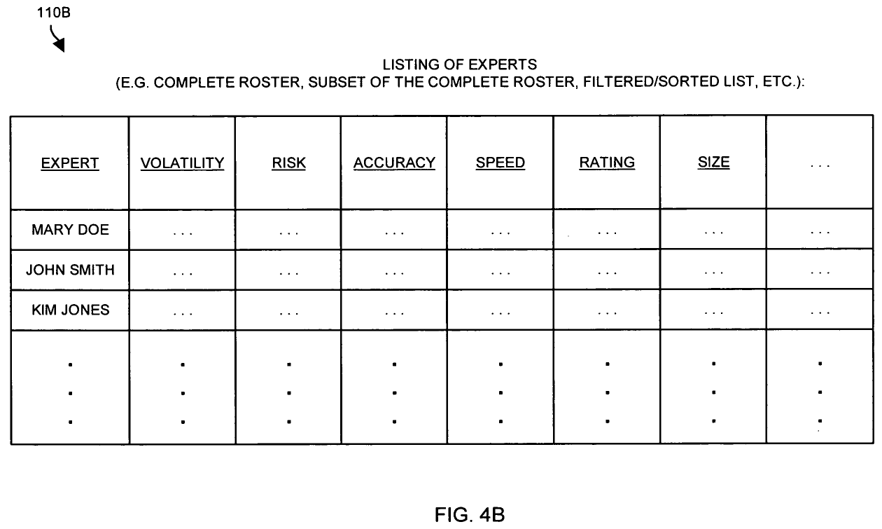

It should be understood that the controller 62 is equipped to perform other operations as well. For example, the other control circuitry 72 is capable of carrying out routine tasks such as upgrades, backup and general servicing. In the context of stock trading, the other control circuitry 72 is further capable of tying into other services such as stock markets for access to stock quotes, for allocating stock exchange fees, and so on. Moreover, the other memory 80 is capable of storing additional information such as informational web pages (securities information, market research, etc.) that are of interest to the experts and users. Further details of the data collection features of the system 20 will now be provided with reference to FIGS. 3, 4A and 4B.

### Data Collection

FIGS. 3, 4A and 4B show general diagrams illustrating some of the expert information which the data collection and processing engine 68 collects and stores in the transaction database 76 (FIG. 2). The data collection and processing engine 68 additionally processes the expert information to derive performance data. FIG. 3 is a general expert diagram 100 of some example data for a particular expert registered in the system 20. FIGS. 4A and 4B are general roster diagrams 110A, 110B of a roster of experts registered in the system 20.

By way of example only, the diagrams 100, 110A, 110B show information in the context of expert stock traders. Although the diagrams 100, 110A, 110B present the expert information in a logical manner for expert stock traders, it should be understood that the expert information is capable of being stored electronically in a standard database format and in a comprehensive manner but which is configured for quick search and retrieval response time.

As shown in FIG. 3, the transaction database 76 includes consumer transaction data (e.g., trade data) for trades by an expert (e.g., “EXPERT_{—}1”) for the past year. Some of the example information (e.g., stock name, buy price, sell price, quantity, transaction dates, date bought, date sold, etc.) is information captured directly from the electronic notification signal 38 reporting the actual expert consumer transactions. Other example information (e.g., gain/loss, period held, annualized gain, overall percent gain, S&P Index performance during the same period, other index performance over the same period, and so on) is derived from the captured information.

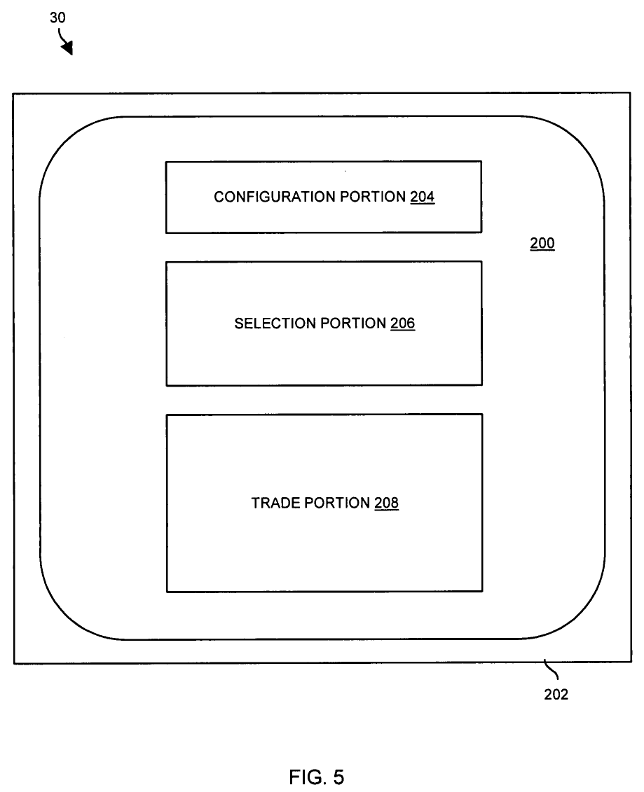

Since the transaction database 76 stores consumer transaction data for each expert registered in the system 20, the information as whole represents consumer transaction data for the entire roster of experts of the system 20. FIGS. 4A and 4B show side-by-side comparisons of certain performance information for multiple experts in the system 20. The system 20 makes such information available to users to facilitate selection of experts to follow. Such information is capable of being provided by the system 20 in a single window, or in two or more windows for user flexibility. Further details of the expert selection features of the system 20 will now be provided with reference to FIG. 5.

### Expert Selection

FIG. 5 is a general block diagram of a display screen 200 of a display 202 of a user device 30 (also see FIG. 1). The display screen 200 includes a configuration portion 204, a selection portion 206, and a trade portion 208. In some arrangements, the display screen 200 is implemented as a set of web pages (i.e., one or more web pages) which are viewable via an Internet browser. In other arrangements, the display screen 200 is implemented as a sophisticated GUI which enables the user to input information into and output information from the system 20 in a client/server manner using an available communications protocol (e.g., TCP/IP, etc.). Although the configuration portion 204, the selection portion 206, and the trade portion 208 are shown together within the display screen 200, it should be understood that the display 30 is capable of rendering each portion 204, 206, 208 to the user individually (e.g., in sets of web pages, in individual dialog boxes/windows, etc.) in a user friendly and well-organized manner.

The configuration portion 204 is configured to get the user started in the system 20. In particular, the user provides user information into the system 20 (e.g., a proposed username, a proposed password, address information, payment information, contract acceptance, etc.) to sign up as a user that follows expert transactions. If any of the information changes over time, the user is capable of going back to the configuration portion 204 to update that information. The user device 30 is configured to communicate with the system 20 to effectuate this user information exchange (also see the electronic sign up signals 40 in FIG. 1).

The selection portion 206 is configured to assist the user in a choice of an expert for the user to follow. In particular, the user enters a variety of search criteria to enable the system 20 to identify a subset of experts from the full roster of available experts (e.g., see FIG. 4). In the context of stock trades, the user is capable of entering investment criteria and performance criteria such as a minimum average return (e.g., over 90 days, over the past year, over the past three years, etc.), an average trade amount, a trade velocity (e.g., every seven days, every 10 days, every 15 days, etc.) and a risk factor (e.g., a weighted average variance/fluctuation). The system 20 then allows the user to filter and sort experts based on these criteria until the user identifies an expert to follow. The user then informs the system 20 of the chosen expert (also see the electronic selection signal 42 in FIG. 1).

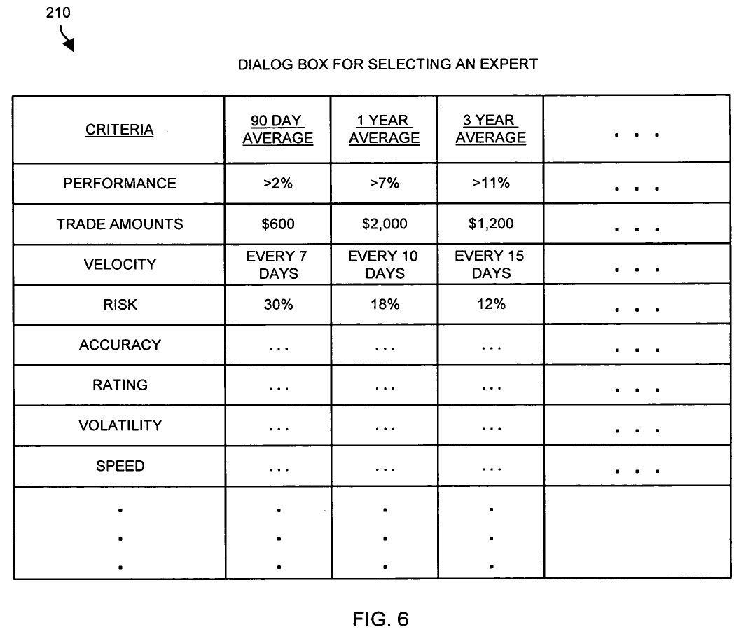

FIG. 6 is an example of a dialog box 210 which is suitable as at least part of the selecting portion 206. In the context of stock trading, the selection criteria include performance (i.e., gain/loss), average trade amounts, average trade velocity, risk, accuracy, rating, volatility, speed, etc. for different time periods (e.g., 30 days, 90 days, one year, 3 years, etc.). Performance is the average annualized return for an expert over the given period of time. The trade amounts are the average amounts per trade. Velocity is how often an expert is buying or selling a financial instrument. Risk is the amount of risk assumed by an expert for a particular time period; this would be generated using a retrospective view of the “weighted average variance/fluctuation” of the stocks the expert was buying or selling.

Experts are also capable of being rated on accuracy, i.e., what percentage of their selections (whether they purchase a stock, sell a stock, purchase an option, purchase a put or a call etc.) were “correct.” That is, if the expert buys a stock and the stock goes up, the expert is “correct.” If an expert shorts a stock and the stock goes down in value, the expert is “correct,” and so on. Additionally, experts are capable of being rated on absolute gains, i.e., total dollar gains resulting from their trading activity.

Using the dialog box 210, a user enters various thresholds (e.g., minimum values, maximum values, average targets, etc.) and sends the selection information to the system 20 through a user device 30 (see the electronic selection signals 42 in FIG. 1). Upon receipt of the selection information, the expert/user administration engine 66 of the support equipment 24 narrows down the choices of experts to enable the user to find the best fit. In some arrangements, the expert/user administration engine 66 filters and sorts the experts in a search engine style manner. Once the user finds an expert to follow, the user informs the system 20 of this selection.

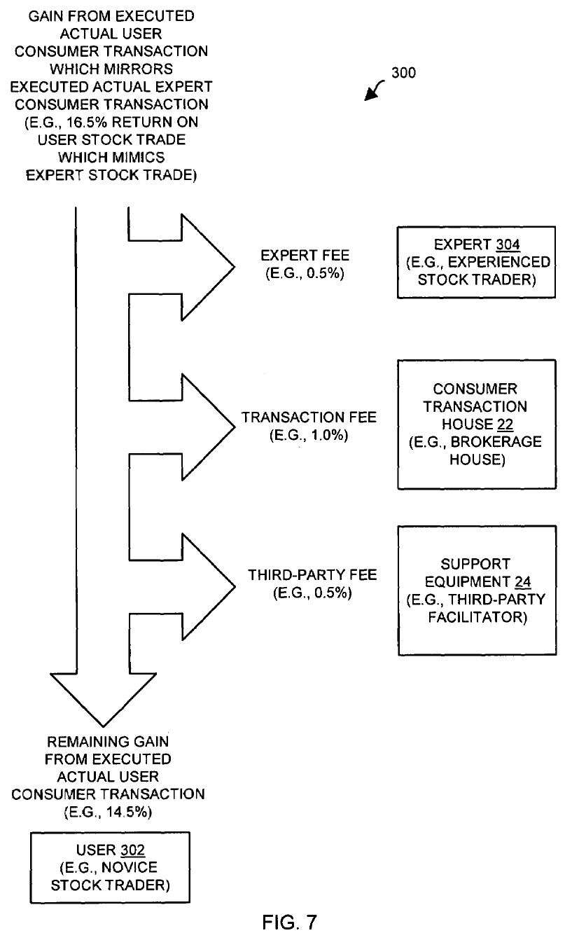

At this point, it should be noted that the features described above in connection with FIGS. 5 and 6 are suitable for use in similar displays for the expert devices 32. That is, the configuration portion 204 and the trade portion 208 of the screen 200 (FIG. 5) are well-suited for enabling an expert to respectively register on the system 20 and execute consumer transactions on the system 20. Furthermore, the selection portion 206 of the screen 200 is well-suited for enabling the expert to consider the possibility of following another expert (i.e., recall that users can be experts and vice versa). Further transaction completion and fee calculation details will now be provided with reference to FIG. 7.

### Transaction Completion and Fee Calculation

The system 20 is well-suited for a variety of consumer transaction scenarios. In particular, the support equipment 24 is capable of managing user/expert involvement in a many different fields including securities trading, gambling, contests, and the like. In these scenarios, the consumer transaction house 22 is essentially a specialized transaction facility that carries out actual/real transactions (e.g., a brokerage house, a casino, etc.). The support equipment 24 coordinates the participation of the experts and the users and reliable and well-organized manner. As a result, all of the parties involved in the process benefit from the system's operation.

It should be understood that the users operate the user devices 30, and the experts operate the expert devices 32 in an ongoing manner. Along these lines, the trade portion 208 of the screen 200 of FIG. 5 enables users and experts to execute actual consumer transactions through the consumer transaction house 22. Over time, people may register as new experts and/or users. Furthermore, users may change experts if they find more desirable experts to follow.

FIG. 7 is a diagram 300 illustrating how each participant benefits from the overall operation of the system 20. This scenario is well-suited in situation when the consumer transaction house 22 and the support equipment 24 if they are owned/operated by different companies, or even the same company.

As shown in FIG. 7, a user 302 produces a gain from execution of an actual user consumer transaction which mirrors an actual expert consumer transaction executed on behalf of an expert 304. From the initial gain (e.g., 16.5%), the transaction and fee calculation engine 70 of the support equipment 24 allocates an expert fee to the expert (e.g., 0.5%), a transaction fee to the consumer transaction house 22 (e.g., 1.0%), and a third-party fee (e.g., 0.5%) for operation of the support equipment 24. The remaining gain (e.g., 14.5%) then goes to the user 304.

As a result of the actual user consumer transaction (e.g., an actual stock trade on behalf of the user), the expert 304 is compensated fairly for allowing the user 304 to follow the expert's actual consumer transaction (e.g., an actual stock trade by the expert carried out before the user's stock trade). Thus, a stock trading expert using the system 20 has an incentive to provide successful stock trades and to share the successful stock trade information with others.

Additionally, the consumer transaction house 22 is compensated fairly for executing the consumer transaction on behalf of the user 304. Moreover, the consumer transaction house 22 benefits by having a close affiliation or partnership with the support equipment 24, i.e., the consumer transaction house 22 receives business from the support equipment 24 rather than looses such business to a competitor, and thus is more willing to assist the operator of the support equipment 24 in the process of creating and maintaining the transaction database 76. In some arrangements, the consumer transaction house 22 charges a transaction fee that is less than a regular transaction fee that is charged to non-participating customers in view of the volume of transactions generated by the support equipment 24.

Furthermore, the operator of the support equipment 24 is compensated fairly for facilitating the following operation between users and experts. That is, as a third-party facilitator, the operator of the support equipment 24 adds value by bringing experts and users together (e.g., the support equipment is capable of putting average stock investors in position to follow expert stock traders).

One will appreciate that other fees can be processed by the system 20 as well. For example, the system 20 is capable of handling exchange fees which are normally attached to the sale of stocks by the exchanges.

### Overview

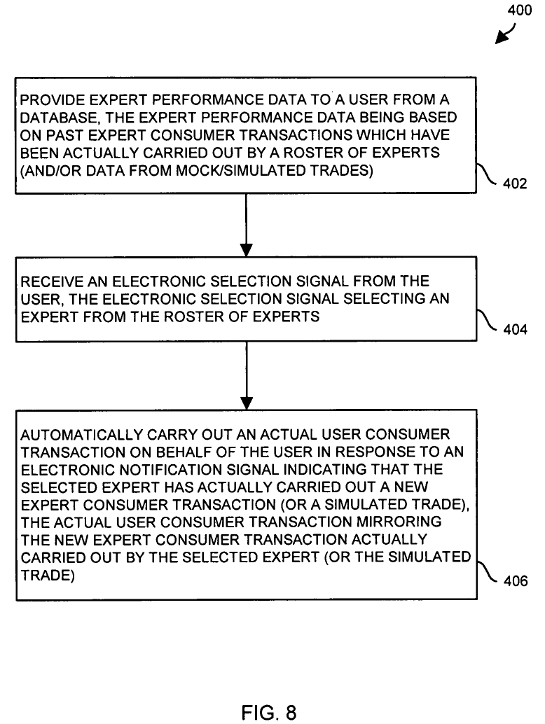

FIG. 8 shows a flowchart 400 which summarizes the operation of the support equipment 24 of the system 20. In step 402, the support equipment 24 provides expert performance data to a user from a database. The expert performance data is based on past expert consumer transactions which have been actually carried out by a roster of experts (see the transaction database 76 in FIG. 2).

In step 404, the support equipment 24 receives an electronic selection signal 42 from the user (FIG. 1). The electronic selection signal 42 selects an expert from the roster of experts.

In step 406, the support equipment 24 automatically carries out an actual user consumer transaction on behalf of the user in response to an electronic notification signal 38 (FIG. 1) indicating that the selected expert has actually carried out a new expert consumer transaction. The actual user consumer transaction mirrors the new expert consumer transaction actually carried out by the selected expert.

As described above, improved techniques are capable of effectuating actual consumer transactions (e.g., stock trades) in an automated manner. Such techniques involve a user choosing an expert to follow from a roster of experts based on a user-performed review of historical expert performance data. After the user has selected an expert to follow, the user configures electronic equipment 24 to carry out a new user consumer transaction on behalf of the user in response to a new expert consumer transaction performed by the chosen expert. As a result, the electronic equipment 24 carries out the new consumer transaction to mirror (or mimic) the transaction of the chosen expert in a quick, effective and dependable manner. Moreover, the electronic equipment 24 is capable of tracking such operation to enable a fair fee to be provided to the chosen expert as well as a fair transaction fee to be provided to the provider/maintainer of the electronic equipment 24.

While various embodiments of the invention have been particularly shown and described, it will be understood by those skilled in the art that various changes in form and details may be made therein without departing from the spirit and scope of the invention as defined by the appended claims.

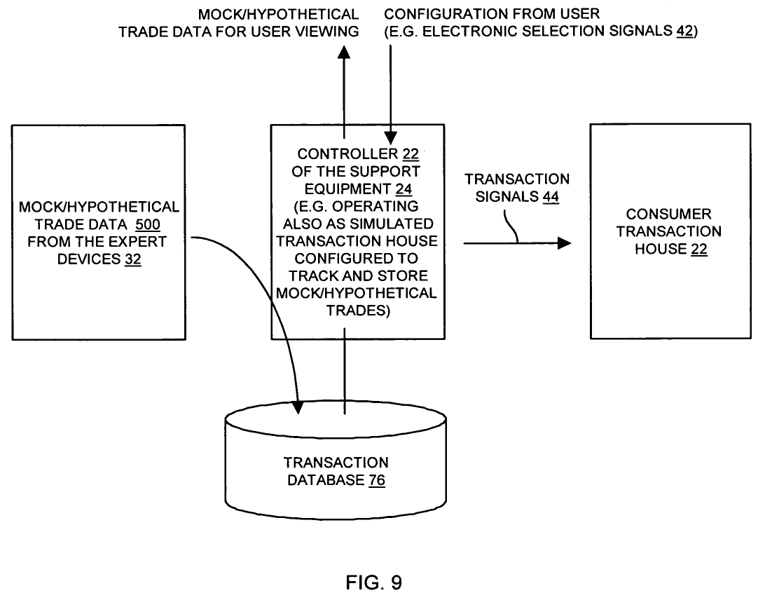

For example, the system 20 was described above as carrying out actual user consumer transactions which mirror actual expert consumer transactions. In some arrangements, the system 20 is capable of carrying out actual user consumer transactions which mirror simulated expert trades, i.e., mock/hypothetical consumer transactions. FIG. 9 shows a situation in which the controller 62 of the support equipment 24 is configured to accumulate mock/hypothetical trade data 500 which it then stores in the transaction database 76 (also see FIG. 2). This mock/hypothetical trade data 500 is provided from the expert devices 32 (FIG. 1) to the support equipment 24 as experts execute mock/hypothetical trades preferably in real time (also see the data collection and processing engine 68 in FIG. 2). Alternatively, this mock/hypothetical trade data 500 is supplied to the support equipment 24 by an external source other than the expert devices 32, e.g., an external device that captures and stores simulated consumer transactions (e.g., a website that enables people to make mock stock trades), the consumer transaction house 22, and so on. The controller 62 responds by processing this data 500 in a manner similar to that performed for the actual data as described earlier in connection with FIGS. 3, 4A and 4B.

Once the mock/hypothetical trade data 500 (FIG. 9) is stored within the transaction database 76, the controller 62 is capable of providing the data 500 to a user for viewing. In particular, the controller 62 provides this data 500 to a display screen 200 of a display 202 of a user device 30 (also see FIG. 5 and step 402 of FIG. 8). The user is capable of viewing this data 500 for expert selection purposes and for configuring the system 20 to follow future mock/hypothetical trades 500 (see the selection portion 206 and the trade portion 208 of the display screen 200 in FIG. 5). That is, the user is capable of configuring the system 20 to mirror future simulated trades (i.e., mock or hypothetical trades which are accumulated by the support equipment 24) performed by one or more experts in generally the same way that the user is capable of configuring the system 20 to mirror actual trades (also see the electronic selection signal 42 in FIG. 1 and step 404 in FIG. 8).

The controller 62 is then capable of directing the consumer transaction house 22 to execute actual user trades based on expert simulated trades in an automated manner (step 406 in FIG. 8). In particular, the transaction and fee calculation engine 70 of the controller 62 sends user transaction signals 44 to the consumer transaction house 22 to effectuate actual user consumer transactions which mirror the simulated expert trades in an automated manner (also see FIGS. 1 and 2). In a similar manner to that described above, the user is capable of choosing one or more experts, or a complete set or subset of the selections of one or more expert selections. Furthermore, the user is able to “opt in” on a transaction-by-transaction basis for improved flexibility and decision-leveraging.

As a result, users are capable of following actual performance data or data based on performance of simulated trading, or both. This feature is well-suited for a variety of situations. For example, this feature is suitable at system start-up time when actual performance data may not very available but when simulated trading data is abundantly available. This feature is also suitable for users wishing to follow experts who are willing to reveal their simulated trades but who are reluctant to reveal their actual trades.

Additionally, the system 20 was described above as being separated by a network 26. In some arrangements, the support equipment 24 and the consumer transaction house 22 of the system 20 are closely integrated together (e.g., running on a same set of computers). In some of these arrangements, the consumer transaction house 22 and the support equipment 24 reside at the same location. For example, the consumer transaction house 22 and the support equipment 24 are implemented on computer circuitry of the same company.

In should now be appreciated that the above-described techniques enable a methodology and system which allows certain individuals (i.e., users) to “follow” or “copy” or “mimic” the activity of others (i.e., experts) using the Internet or any device connected to a network of other people (e.g. PCs connected to the Internet; mobile devices that communicate with a wireless network etc.). There are people (and/or institutions) around the world who are “latent experts” at something. While that something or their “latent expertise” may not be their primary business or something they make a living at full-time, they may in fact be as good or better at the activities than the people who are employed full-time at the specific activity who do in fact make their living from a specific activity i.e. “full-time professionals.” For purposes we will define these “latent experts” as simply experts. The above-described techniques enable a person or a group of people to mimic the behavior of these experts. As a result, the users (or “followers”) benefit from the actions of the experts. Moreover, the experts in turn also derive some benefit by having people follow them.

It should be further appreciated that the system 20 is well-suited for a variety of applications including trading of financial instruments, equity and derivatives trading, trading of other financial instruments (e.g. options, debt, foreign exchange instruments, etc.), poker, blackjack, horse racing, other types of gambling, contests in general, video games that are constructed between multiple parties, and so on.

In the context of financial instrument trading, there are many people around the world who are employed as full-time/professional “money managers.” This may be in the form or Mutual Fund Manager or a Stock Broker, etc. These people are paid to manage an investor's money in order to yield as positive a return on the investment as possible. Yet, there are many cases, which have been documented in various publications, where the professional “Money Manager” performs no better than a monkey randomly throwing darts at a list of stocks on say the New York Stock Exchange or NASDAQ. There are also many cases where for example, the professional money manager performs worse than an index that represents and overall market performance in general e.g. performs worse than what the same investment in an S&P 500 index would have yielded.

Conversely, there are individuals in the general public who are not paid as full-time professional Money Managers and are not licensed to do so and who may make their living at something other than their “latent expertise.” Yet these “latent experts” may in fact perform better than a professional Money Manager over a given period of time (weeks, months, quarters, years). Advantageously, the system 20 is capable of giving a group of users (i.e. “followers” or “Associates”) access to the behaviors and actions of these “latent experts” and allowing the users to benefit from the actions of the experts by simply “following/mimicking” the actions/behavior of the experts without necessarily knowing how or why the experts perform well. That is, a users follows an expert by having access via the system 20 (e.g., through the Internet or a mobile device or any network) to the history and performance of the expert and identifying that the user wants to “follow” the expert. The user looks at the performance of an expert or group of experts over time. The user then selects from a listing of experts based on some sorting of selection criteria and then identifies and selects from the list of qualifying experts which expert the user wants to follow. The user then identifies an amount of money that user wants to invest and the money is invested (or divested) in financial instruments that mimic the investment/actions of the expert that the user has selected to follow. The benefits to the user is that the user gets to “ride on the coattails” of a “latent expert” and reap a financial gain without necessarily having to do the homework and have the proper understanding to yield these results on his or her own. The benefits to the expert is that if the user did in fact generate a positive return that met some threshold and the expert did have following users who also generated a positive return by “following/mimicking” the expert, the expert gets a small percentage of each follower's positive return. The third group to benefit would be the institutions that the system 20 uses to do the actual trading through increased volume and access to customers (followers) they otherwise would not have access to.

The system 20 is capable of returning a list of experts who meet the specified criteria based on the parameters input by the “follower/associate” user. The user then is able to choose which expert to “follow.” The user then specifies the amount to invest. This amount would is used to “follow” the selected expert by mimicking the trades of the expert. In some arrangements, this is done on a pro-rata basis. As an example of a pro-rata style of operation that is capable of being carried out by the system 20, suppose that an expert on average traded $154K per trade. Further suppose that a user invests $15K in following the expert. In this example, each time the expert carried out a buy or a sell, the user's investment “copies/mimics” the same trade on a pro-rata basis. In this example (also refer to FIG. 3), it would mean 9.7% ($15K/$154K) if the expert buys 1000 shares of LU since the system 20 is the triggers an investment of 97 shares of LU on behalf of the user. If the expert then sold 500 shares of LU the next day, then the system 20 triggers a “sell” of 49 shares (i.e. 50% of 97 shares) of the user's holdings in LU. The user could also choose to selectively mimic a subset of the trades that the experts are doing.

In some arrangements, the user is able to see what stocks and other financial instruments the experts are trading and, in addition to “following” the experts, the users are capable of buying or selling any of the financial instruments independently through the system 20. In these arrangements; the system 20 preferably reports the user's performance. Accordingly, a person is capable of being both an expert and a user.

What is claimed is:

1. A method for effectuating an actual user consumer transaction, the method comprising:
providing expert performance data to a user from a database, the expert performance data being based on past expert consumer transactions which have been actually carried out by a roster of experts;
receiving an electronic selection signal from the user, the electronic selection signal selecting an expert from the roster of experts; and
automatically carrying out an actual user consumer transaction on behalf of the user in response to an electronic notification signal indicating that the selected expert has actually carried out a new expert consumer transaction, the actual user consumer transaction mirroring the new expert consumer transaction actually carried out by the selected expert.

2. A method as in claim 1 wherein providing the expert performance data to the user from the database includes:
generating, for multiple experts on the roster of experts, sets of expert performance factors corresponding to the multiple experts, and
displaying the generated sets of expert performance factors on a display device to the user.

3. A method as in claim 2, further comprising:
storing, in the database, a history of expert consumer transactions which have been actually carried out by the roster of experts, the generated sets of expert performance factors being derived from the history of expert consumer transactions stored in the database.

4. A method as in claim 3 wherein the multiple experts are security traders; and
wherein displaying the generated sets of expert performance factors on the display device to the user includes:
outputting, on the display device, trading velocity values indicating respective security trading frequencies of the security traders.

5. A method as in claim 3 wherein the multiple experts are security traders; and
wherein displaying the generated sets of expert performance factors on the display device to the user includes:
outputting, on the display device, average hold-time values indicating respective average hold time data of the security traders.

6. A method as in claim 3 wherein the multiple experts are security traders; and
wherein displaying the generated sets of expert performance factors on the display device to the user includes:
outputting, on the display device, average trade values indicating respective average trade value data of the security traders.

7. A method as in claim 3 wherein the multiple experts are security traders; and
wherein displaying the generated sets of expert performance factors on the display device to the user includes:
outputting, on the display device, accuracy scores indicating respective numbers of gaining transactions of the security traders.

8. A method as in claim 3 wherein the multiple experts are security traders; and
wherein displaying the generated sets of expert performance factors on the display device to the user includes:
outputting, on the display device, overall scores indicating respective overall scores of the security traders.

9. A method as in claim 3 wherein the multiple experts are security traders; and
wherein receiving the electronic selection signal from the user includes:
identifying a particular security trader whose security trades the user intends to mirror.

10. A method as in claim 9 wherein automatically carrying out the actual user consumer transaction on behalf of the user in response to the electronic notification signal includes:
electronically purchasing a stock on behalf of the user in response to the electronic notification signal, the electronic notification signal indicating that the particular security trader has actually purchased the stock.

11. A method as in claim 10 wherein electronic notification signal indicates that the particular security trader has purchased a first amount of the stock; and wherein electronically purchasing the stock on behalf of the user includes:
electronically purchasing a second amount of the stock on behalf of the user, the second amount being based on a prorated value which is predefined by the user.

12. A method as in claim 10, further comprising:
receiving an electronic short sale disable signal from the user; and
based on the electronic short sale disable signal, ignoring a subsequent electronic notification signal when the subsequent electronic notification signal indicates that the particular security trader has actually performed a short sale of the stock.

13. A method as in claim 10 wherein electronically purchasing the stock on behalf of the user results in creation of a completed stock transaction; and wherein the method further comprises:
applying a set of transaction fees in response to the completed stock transaction.

14. A method as in claim 13 wherein a third-party manages a web site which provides the expert performance data to the user from the database; and wherein applying the set of transaction fees includes:
allocating a broker fee on behalf of a securities broker in response to the completed stock transaction,
allocating an expert fee on behalf of the selected expert in response to the completed stock transaction, and
allocating a third-party fee on behalf of the third-party in response to the completed stock transaction.

15. A method for effectuating a user consumer transaction, the method comprising:
providing expert performance data to a user from a database, the expert performance data being based on at least one of (i) past expert consumer transactions which have been actually carried out by a roster of experts and (ii) simulated transactions provided by the roster of experts;
receiving an electronic selection signal from the user, the electronic selection signal selecting an expert from the roster of experts; and
automatically carrying out an actual user consumer transaction on behalf of the user in response to an electronic notification signal indicating that the selected expert has inputted a new trade that is one of (i) a new actual expert consumer transaction and (ii) a new simulated transaction, the actual user consumer transaction mirroring the new trade inputted by the selected expert.

16. A system for effectuating an actual user consumer transaction, the system comprising:
an interface constructed and arranged to connect to a network;
a storage assembly constructed and arranged to store a database; and
a controller coupled to the interface and the storage assembly, the controller being constructed and arranged to:
provide expert performance data to a user from the database through the interface, the expert performance data being based on past expert consumer transactions which have been actually carried out by a roster of experts,
receive an electronic selection signal from the user through the interface, the electronic selection signal selecting an expert from the roster of experts, and
automatically carry out an actual user consumer transaction on behalf of the user in response to an electronic notification signal indicating that the selected expert has actually carried out a new expert consumer transaction, the actual user consumer transaction mirroring the new expert consumer transaction actually carried out by the selected expert.

17. A system as in claim 16 wherein the controller, when providing the expert performance data, is constructed and arranged to:
generate, for multiple experts on the roster of experts, sets of expert performance factors corresponding to the multiple experts, and
display the generated sets of expert performance factors on a display device to the user.

18. A system as in claim 17 wherein the storage assembly, when storing the database, is constructed and arranged to:
maintain a history of expert consumer transactions which have been actually carried out by the roster of experts, the controller being constructed and arranged to derive the performance factors from the history of expert consumer transactions maintained in the database.

19. A system as in claim 18 wherein the multiple experts are security traders; and
wherein the controller, when receiving the electronic selection signal from the user, is constructed and arranged to:
identify a particular security trader whose security trades the user intends to mirror.

20. A system as in claim 19 wherein the controller, when automatically carrying out the actual user consumer transaction on behalf of the user in response to the electronic notification signal, is constructed and arranged to:
electronically purchase a stock on behalf of the user in response to the electronic notification signal, the electronic notification signal indicating that the particular security trader has actually purchased the stock.

21. A system as in claim 20 wherein the interface, the storage assembly and the controller reside within third party equipment managed by a third party;
wherein the system further comprises a securities brokerage house in electronic communication with the third party equipment, the securities brokerage house being constructed and arranged to complete the purchase of the stock on behalf of the user; and
wherein the controller is further constructed and arranged to allocate a broker fee on behalf of the securities brokerage house in response to the completed purchase, allocate an expert fee on behalf of the selected expert in response to the completed purchase, and allocate a third-party fee on behalf of the third-party in response to the completed purchase.
